(19) United States
(12) Patent Application Publication
(10) Pub. No.: US 2024/0330572 A1
(43) Pub. Date: Oct. 3, 2024

(54) EDIT OF TEXT LAYER AND IMAGE LAYER IN DOCUMENT INCLUDING HANDWRITTEN TEXT

(71) Applicant: Hewlett-Packard Development Company, LP., Spring, TX (US)

(72) Inventors: Yuna KIM, Seongnam Si (KR); Haekee LEE, Seongnam Si (KR)

(21) Appl. No.: 18/577,848

(22) PCT Filed: Dec. 28, 2021
(86) PCT No.: PCT/US2021/065274

§ 371 Date: Jan. 9, 2024

(30) Foreign Application Priority Data
Jul. 9, 2021 (KR) 10-2021-0090519

(51) Int. Cl. G06F 40/166; G06V 30/22

(52) U.S. Cl. CPC G06F 40/166; G06V 30/22

(57) ABSTRACT

An example electronic apparatus includes a processor and a memory to store instructions executable by the processor. The processor, by executing the instructions, is to obtain, for a document including handwritten text, a text layer including text and an image layer including a handwritten image corresponding to the text, detect text related to an edit request of a user, retrieve, in the text layer, at least one character constituting the detected text, retrieve, in the image layer, at least one character image mapped to the retrieved at least one character, and apply a first handwritten image including the retrieved at least one character image to the image layer.

### BACKGROUND

An image forming apparatus may receive setting information regarding a storage format of a scanned document, a file name, and a destination to which the scanned document is to be transmitted. In a case where a scan job command on a certain document is received by the image forming apparatus, the image forming apparatus may perform a scan job on the certain document, based on setting information. For example, the image forming apparatus may generate a file regarding the scanned document according to a storage format and a file name and transmit the generated file to a destination that is set. In a case where the scanned document includes handwritten text, the handwritten text may be converted to computer readable text through optical character recognition (OCR), intelligent character recognition (ICR), etc.

### BRIEF DESCRIPTION OF THE DRAWINGS

Various examples will be described below by referring to the following figures.

FIG. 1 is a flowchart illustrating a method of editing document data according to an example.

FIG. 2 is a flowchart illustrating a method of recognizing text in an image according to an example.

FIG. 3 illustrates a user interface to recognize text in an image according to an example.

FIG. 4 illustrates document data according to an example.

FIG. 5A is a flowchart illustrating a method of editing document data according to an example.

FIG. 5B is a flowchart illustrating a method of editing document data according to an example.

FIG. 6 illustrates an example of deleting content in document data.

FIG. 7 illustrates an example of retrieving text to insert content in document data.

FIG. 8 illustrates an example of inserting content in document data.

FIG. 9 illustrates an example of inserting content in document data.

FIG. 10 illustrates an example of retrieving text to replace content in document data.

FIG. 11 illustrates an example of replacing content in document data.

FIG. 12 illustrates an example of document data whose content is edited.

FIG. 13 is a flowchart illustrating a method of editing document data according to an example.

FIG. 14 illustrates an example of searching for a font in order to insert content in document data.

FIG. 15 is a block diagram illustrating an electronic apparatus according to an example.

FIG. 16 is a diagram illustrating instructions stored in a non-transitory computer-readable recording medium according to an example.

### DETAILED DESCRIPTION

Hereinafter, examples will be described with reference to the accompanying drawings. However, the present disclosure may be implemented in various different forms and is not limited to the examples described herein.

Terms including ordinals such as first, second, etc. may be used to identify various components, but the components are not limited by the terms. These terms are used for the purpose of distinguishing one component from another. For example, a first component may be referred to as a second component, a second component may be referred to as a first component, and their ordinal number may be omitted.

An “electronic apparatus” may refer to an apparatus that is to receive a user's command and display information processed according to the user's command. The electronic apparatus may be, for example, an image forming apparatus, a Personal Computer (PC), a tablet PC, a Personal Digital Assistant (PDA), a laptop, a smartphone, a mobile phone, or the like. In the electronic apparatus, a program related to the operation of the electronic apparatus or an external apparatus may be installed. For example, a program related to an operation described below may be installed on the electronic apparatus.

An “image forming device” may refer to any kind of device capable of performing an image forming operation, such as a printer, a copier, a scanner, a fax machine, a multi-function printer (MFP), a display device, etc. The image forming device may also be a two-dimensional (2D) image forming device or a three-dimensional (3D) image forming device. An “image forming operation performed by the image forming device” may be an operation related to printing, copying, scanning, faxing, storage, transmission, coating, etc., or a combination of two or more of the operations described above.

“Document data” may refer to data related to a text layer and an image layer. For example, the document data may include the text layer and the image layer. The document data including the text layer and the image layer may be referred to as searchable document data. The document data may include three or more layers. For example, the document data may include a text layer, an image layer, a table layer, etc. The document data may be in a portable document format (PDF), but is not limited thereto. The document data may indicate a document including handwritten text.

Document data may include an image layer without a text layer, and the document data including the image layer may be referred to as image-only document data. The image-only document data may be a PDF, but is not limited thereto. For example, the image-only document data may be image data, and the image data may be an image file having an extension such as JPG, TIFF, BMP, PNG, etc. The image data may include a plurality of image pages. Text may be recognized from the image-only document data or the image data by text recognition, and the recognized text may be saved in a text layer.

An “image layer” of document data may be a layer in which information regarding an image of the document data is saved. For example, before text of scanned or captured document data is recognized by using OCR, ICR, etc., the document data may include an image layer without a text layer.

A “text layer” of a document may be a layer in which information regarding text of the document data is saved. For example, after text of scanned or captured document data is recognized by using OCR or ICR, the document data may include an image layer and a text layer. Computer readable text may be generated through OCR, ICR, etc. by recognizing handwritten text included in a document.

An image layer and a text layer related to document data may be saved by being included in the document data, but examples are not limited thereto. For example, a scan image generated by scanning an image, and text recognized from the scan image may be saved in a memory and related to the document data. The scan image and text may be saved as a PDF in the memory, but examples are not limited thereto.

An image layer of document data or a text layer of document data may be saved in a memory, and the image layer and the text layer saved in the memory may be saved by being included in the document data based on a user or a predetermined condition.

An expression such as an image layer of document data or a text layer of document data is not limited to the document data including the image layer or the text layer, and may indicate an image layer or a text layer which can be saved by being included in the document data. For example, an image layer of document data may indicate a scan image stored in a memory by scanning an image. For example, a text layer of document data may indicate text recognized from a scan image and stored in a memory. The scan image and its corresponding text stored in the memory may be saved by being included in the document data.

A text layer and an image layer of document data may be mapped to each other. For example, in a case where OCR, ICR, etc. is performed on document data which is hand-written by a user, a user's handwritten text image may be mapped to text recognized through OCR, ICR, etc. Document data may store information regarding mapping between an image layer and a text layer. The information regarding mapping may be saved in both or either one of the image layer and the text layer, or may be saved in a region other than layers of the document data.

An image layer of document data may include a handwritten image, and the handwritten image may be converted to computer readable text through OCR, ICR, etc.

A text layer of document data may include text, and the text may be text converted by OCR, ICR, etc. to be computer-readable.

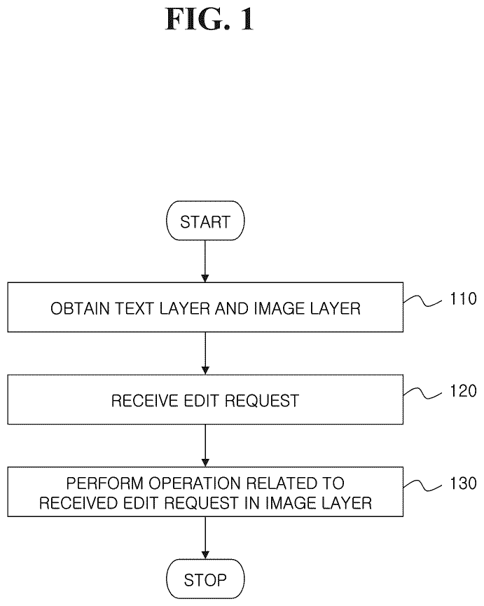

FIG. 1 is a flowchart illustrating a method of editing document data according to an example.

Referring to FIG. 1, an electronic apparatus may obtain a text layer and an image layer in operation 110. The obtained text layer and image layer may be related to document data. For example, the text layer and the image layer may be included in the document data. OCR, ICR, or the like may be performed on document data which does not include a text layer or is not related to a text layer, to recognize text of the document data, and the document data may be related to the text layer including the recognized text.

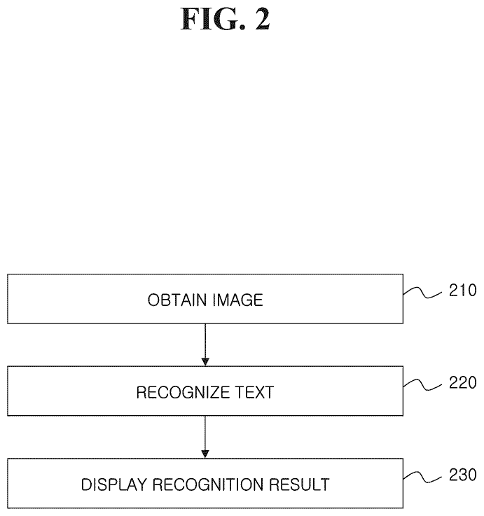

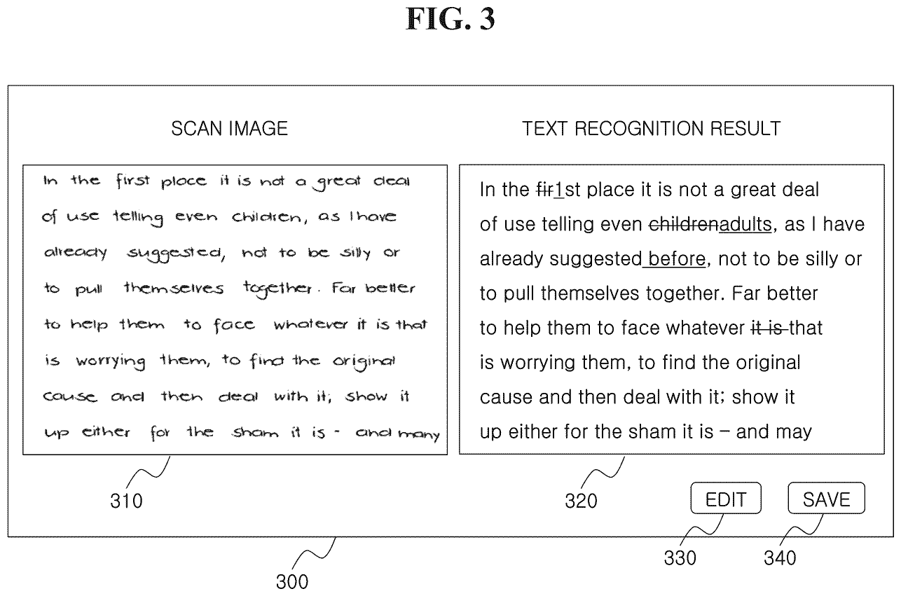

In operation 120, the electronic apparatus may receive an edit request of a user. The edit request may be an edit request for the text layer, but is not limited thereto. An example process of receiving an edit request will be explained later by referring to FIGS. 2 and 3.

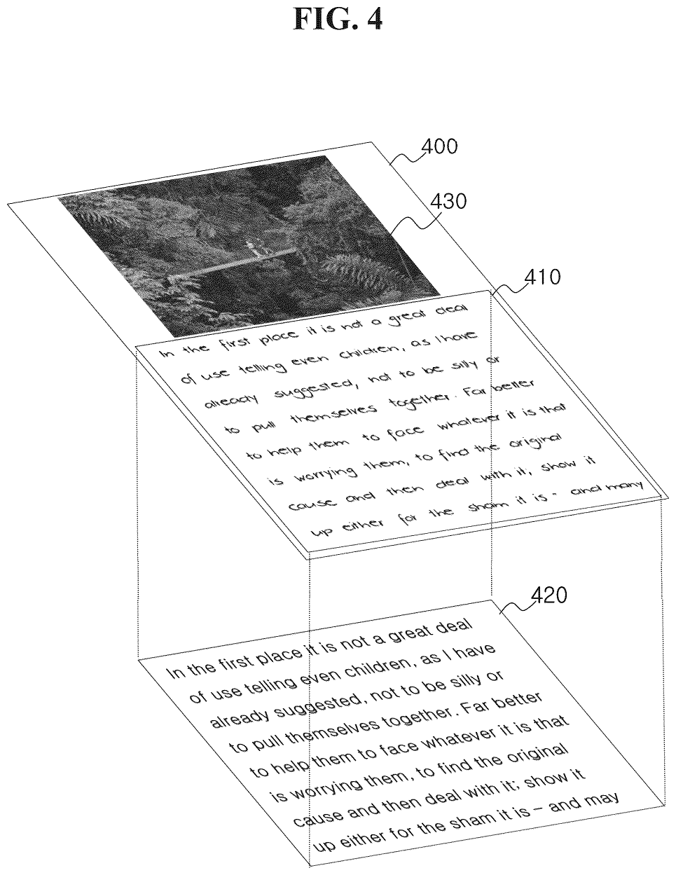

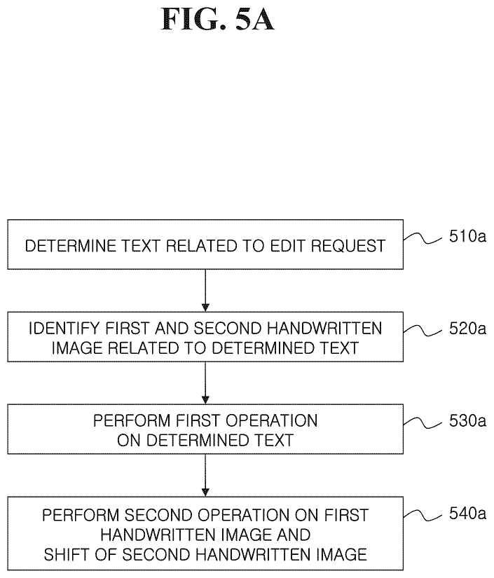

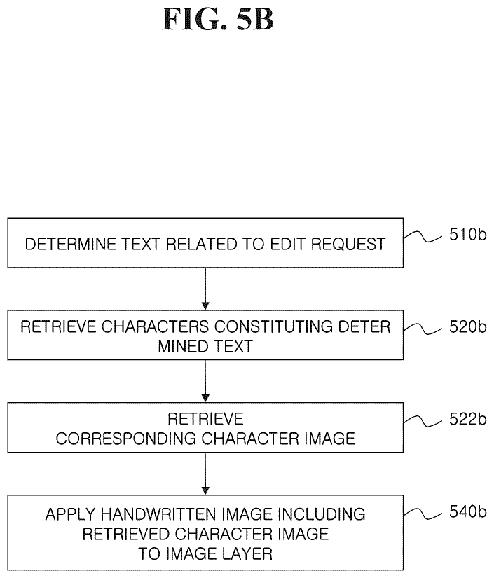

In operation 130, the electronic apparatus may perform an operation related to the edit request in the image layer. Unless otherwise described, an operation performed on the text layer is referred to as a first operation, and an operation performed on the image layer is referred to as a second operation. Examples of an image layer and a text layer will be explained later by referring to FIG. 4. Example operations related to an edit request and performed in the image layer will be explained later by referring to FIGS. 5A, 5B, 6, 7, 8, 9, 10, 11, 12, 13, and 14.

FIG. 2 is a flowchart illustrating a method of recognizing text in an image according to an example.

FIG. 3 illustrates a user interface (UI) to recognize text in an image according to an example.

Referring to FIG. 2, the electronic apparatus may obtain an image in operation 210. For example, the electronic apparatus may be connected to or mounted to an image forming device, or may be the image forming device itself. The image may be image-only document data. Referring to FIG. 3, the electronic apparatus may obtain an image 310 which is scanned or captured by the image forming device. The image 310 which is scanned or captured, that is, a scan image 310 may be provided to a user through a UI 300 of the electronic apparatus. The user may detect whether the scan has been performed properly through the scan image 310 displayed through the UI 300. As shown in FIG. 3, the scan image 310 may be related to an image layer including handwritten images. The scan image 310 may be related to a text layer including text by text recognition described later.

In operation 220, the electronic apparatus may recognize text from the scan image 310. As described above, the electronic apparatus may recognize text included in the scan image 310 through OCR, ICR, or the like.

In operation 230, the electronic apparatus may display a recognition result. Referring to FIG. 3, the text of the scan image 310 is recognized, and a text recognition result 320 may be displayed through the UI 300 of the electronic apparatus.

Referring to FIG. 3, a user may select an edit button 330 to edit the text of the text layer. For example, as shown in FIG. 3, the user may replace “fir” with “1”, replace “children” with “adults”, insert “before”, and delete “it is”. An insertion bar to indicate an edit location related to the edit request of the user may be displayed in the text recognition result 320. The insertion bar may indicate a text insertion location. For example, text may be inserted at a location where the insertion bar is located. As text is inserted, the insertion bar is moved to the right in left-to-right horizontal text. In an example, the insertion bar may indicate a text deletion location. For example, text located to the left of the insertion bar may be deleted if the insertion bar is moved to the left, but is not limited thereto. For example, text selected by a drag input may be deleted.

A handwritten image corresponding to a text edit location may indicate a handwritten image located next to the text edit location. For example, a handwritten image corresponding to a text insertion location may include a handwritten image which comes after the text insertion location. The text insertion location and its corresponding handwritten image may be located in the same line. A handwritten image corresponding to a text deletion location may include a handwritten image which comes before the text deletion location.

FIG. 3 illustrates that an edit request of a user is received at a text layer, but is not limited thereto. For example, an insertion bar may be displayed on a scan image 310, and an edit request of a user may be received at an image layer, that is, the scan image 310. Examples of deleting, inserting, and replacing text will be explained below by referring to FIGS. 5A, 5B, 6, 7, 8, 9, 10, 11, 12, 13, and 14.

FIG. 3 illustrates that the text recognition result 320 shows an edit history of a document, but examples are not limited thereto, and the text recognition result 320 may display a final version of the document. A user may select a save button 340 to save the edited image layer and text layer as being included in document data. The document data may be stored in a memory of the electronic apparatus, but examples are not limited thereto. For example, the document data may be stored in a server or cloud server outside the electronic apparatus.

FIG. 4 illustrates document data according to an example.

Referring to FIG. 4, an image layer 410 and a text layer 420 are illustrated as included in document data 400, but examples are not limited thereto. The image layer 410 and the text layer 420 may indicate information that is stored in a memory, but is not included in the document data yet.

Referring to FIG. 4, the document data 400 may include the image layer 410 and the text layer 420. The document data 400 may further include a graphic object 430.

The image layer 410 may include a handwritten image that is written by a user. Text may be recognized from the handwritten image included in the image layer 410 through OCR, ICR, or the like, and the recognized text may be saved in the text layer 420. The image layer 410 and the text layer 420 may be mapped to each other. That is, a handwritten image and text converted from the handwritten image may be mapped to each other. Mapping information of the handwritten image and the converted text may be stored in the document data 400. The mapping information may be stored in both or either one of the image layer 410 and the text layer 420.

As shown in FIG. 3, in a case where a user edits text, that is, a change occurs in the text layer 420, such change may be applied to the image layer 410, an example of which will be explained by referring to FIGS. 5A and 5B.

FIG. 5A is a flowchart illustrating a method of editing document data according to an example.

Referring to FIG. 5A, the electronic apparatus may detect text related to an edit request of a user in operation 510a. For example, the electronic apparatus may detect the text related to the edit request for document data. The edit request for the document data may include deletion, insertion, and replacement of content in the document data.

For example, text related to a deletion request in document data may correspond to content that a user wants to delete from the document data. For example, text related to an insertion request in document data may correspond to content that a user wants to insert to the document data. For example, text related to a replacement request in document data may correspond to content that a user wants to delete from the document data and content that the user wants to insert to the document data.

Text related to an edit request may be included in a text layer, but is not limited thereto. For example, text related to a deletion request may be existing text included in the text layer. For example, text related to an insertion request may be text not included in the text layer The text related to the insertion request may include characters included in the text layer. For example, text to be deleted of text related to a replacement request may be existing text included in the text layer. Text to be inserted of the text related to the replacement request may be text not included in the text layer. The text to be inserted may include characters included in the text layer. The text to be deleted and the text to be inserted of the text related to the replacement request may be referred to as target text and replacement text, respectively.

In operation 520a, the electronic apparatus may identify a first handwritten image and a second handwritten image related to the detected text. The first handwritten image may be a handwritten image mapped to the text related to the edit request. For example, the first handwritten image may be a handwritten image mapped to the text related to the deletion request. In a case where the text related to the deletion request is included in the text layer, the first handwritten image may be a handwritten image mapped to the text related to the deletion request. In a case where characters constituting the text related to the insertion request are included in the text layer, the first handwritten image may be a handwritten image mapped to the characters. A handwritten image mapped to characters may be referred to as a character image. For example, the first handwritten image may be a handwritten image mapped to the text related to the replacement request. For example, the first handwritten image may be a handwritten image mapped to a target text, a handwritten image mapped to a replacement text, and character images mapped to characters constituting the replacement text.

In operation 530a, the electronic apparatus may perform a first operation for the detected text. For example, the electronic apparatus may perform, for text related to an edit request, an operation related to the edit request. For example, the electronic apparatus may delete text related to a deletion request, insert text related to an insertion request, and replace text related to a replacement request.

In operation 540a, the electronic apparatus may perform a second operation for the first handwritten image, and perform a shift of a second handwritten image.

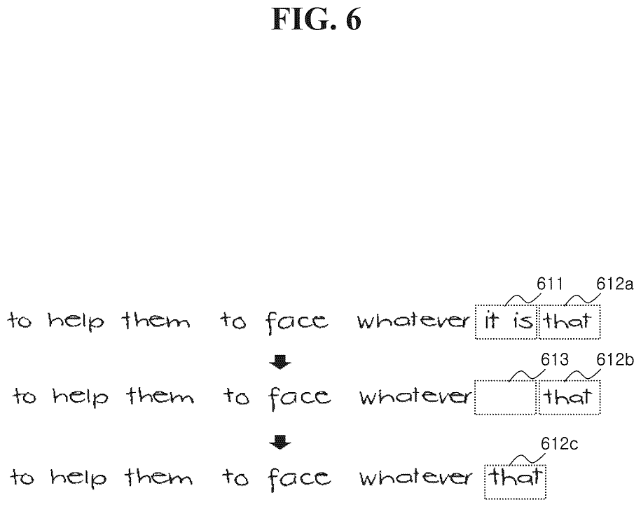

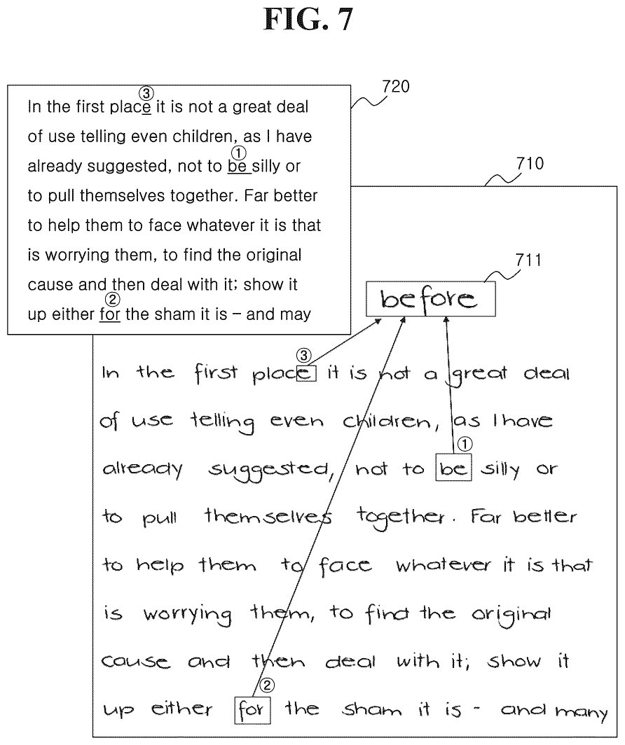

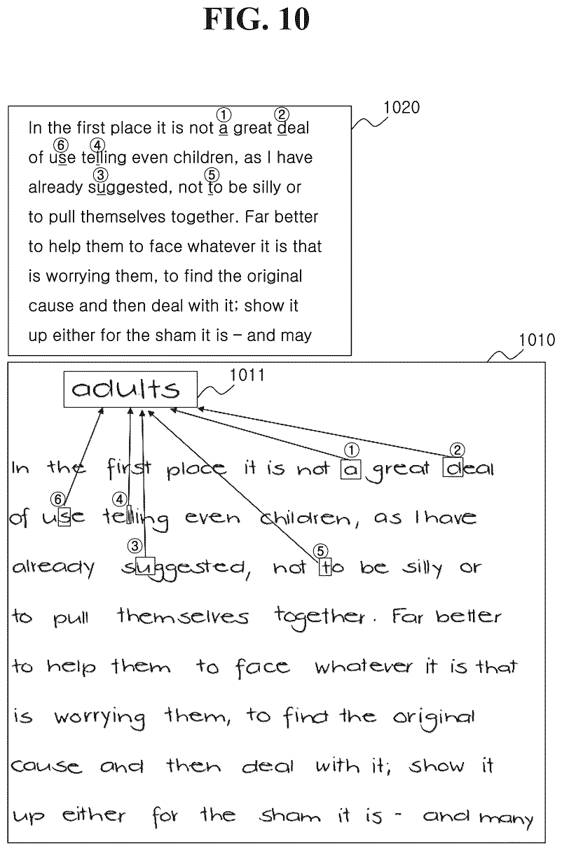

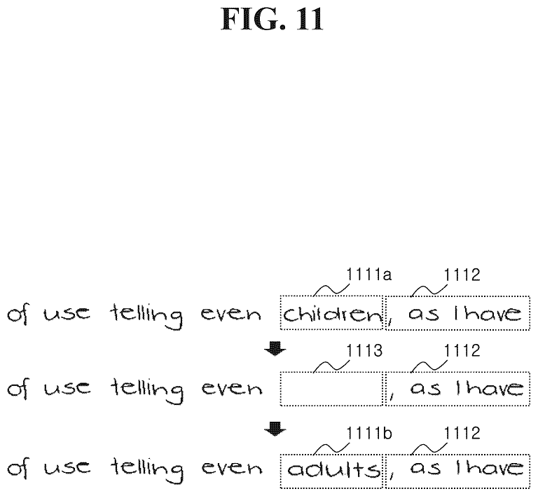

The second operation for the first handwritten image may correspond to the first operation in operation 530a. For example, in a case where text detected in operation in 530a is to be deleted from the text layer, the second operation of deleting, covering, or hiding the first handwritten image may be performed, an example of which will be explained later by referring to FIG. 6. For example, in a case where text detected in operation in 530a is to be inserted to the text layer, the second operation of applying the first handwritten image may be performed, an example of which will be explained later by referring to FIGS. 7. 8, and 9. For example, in a case where text detected in operation in 530a is to be deleted to be replaced with other text in the text layer, the second operation of replacing the first handwritten image may be performed, an example of which will be explained later by referring to FIGS. 10 and 11. Applying a handwritten image to the image layer may correspond to performing, based on the first operation performed on text detected in the text layer, the second operation on the handwritten image in the image layer. Applying a handwritten image to the image layer may correspond to performing the second operation on the first handwritten image related to the handwritten image in the image layer and shifting the second handwritten image related to the handwritten image. Applying a handwritten image to the image layer may include presenting, generating, pasting, or adding the handwritten image on the image layer, but is not limited thereto. The handwritten image may be applied to the image layer in various ways according to the first operation performed in the text layer.

The second handwritten image may be a handwritten image which is shifted in the image layer. The second handwritten image may be adjacent to the first handwritten image. For example, a handwritten image located to the right of the first handwritten image related to a deletion request may be the second handwritten image. An example of shifting the second handwritten image in response to receiving the deletion request will be explained later by referring to FIG. 6. A handwritten image located to the right of the position at which the first handwritten image to be applied in the image layer, that is, located to the right of the text insertion location, may be the second handwritten image. An example of shifting the second handwritten image in response to receiving the insertion request will be explained later by referring to FIGS. 7, 8, and 9. The shift of the second handwritten image may not be performed, an example of which will be explained later by referring to FIGS. 10 and 11.

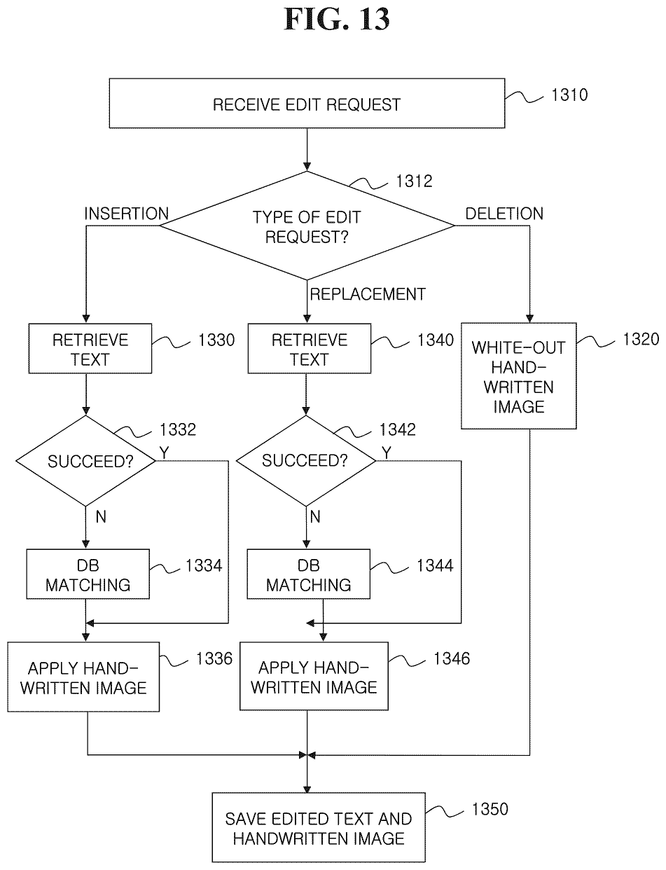

FIG. 5B is a flowchart illustrating a method of editing document data according to an example. The example method illustrated in FIG. 5B may correspond to an operation to insert text, for example, operations 1330, 1332, 1334, and 1336 in FIG. 13, or an operation to replace text, for example, operations 1340, 1342, 1344, and 1346 in FIG. 13.

Referring to FIG. 5B, the electronic apparatus may detect text related to an edit request of a user in operation 510b. For example, the electronic apparatus may detect the text related to the edit request for document data. The edit request for the document data may include insertion and replacement of content in the document data.

For example, text related to an insertion request in document data may correspond to content that a user wants to insert to the document data. For example, text related to a replacement request in document data may correspond to content that a user wants to delete from the document data and content that the user wants to insert to the document data.

Text related to an insertion request may be text which is not included in a text layer. The text related to the insertion request may include characters included in the text layer. Text to be inserted of the text related to the replacement request may be text not included in the text layer. The text to be inserted may include characters included in the text layer. Text to be deleted of the text related to the replacement request may be existing text included in the text layer. The text to be deleted and the text to be inserted of the text related to the replacement request may be referred to as target text and replacement text, respectively.

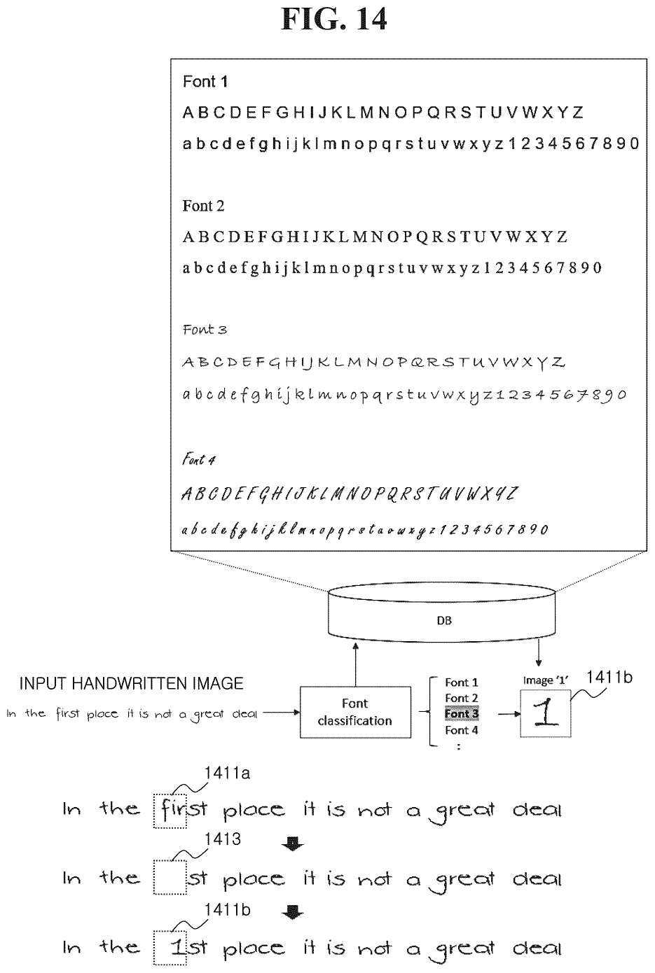

In operation 520b, the electronic apparatus may retrieve characters constituting the text related to the edit request. For example, the electronic apparatus may retrieve characters constituting text related to a text insertion request. For example, the electronic apparatus may retrieve characters constituting replacement text related to a text replacement request. Characters may be retrieved from the text layer, but are not limited thereto. For example, the electronic apparatus may perform database (DB) matching with a font library to retrieve characters constituting the text related to the edit request, an example of which will be explained later by referring to FIG. 14.

In operation 522b, the electronic apparatus may retrieve a character image corresponding to the retrieved characters. A character image mapped to the retrieved character in the text layer may be retrieved from the image layer, but is not limited thereto. For example, the electronic apparatus may perform DB matching with a font library to retrieve characters constituting the text related to the edit request, and retrieve, from the font library, a character image corresponding to the retrieved character, an example of which will be explained later by referring to FIG. 14.

In operation 540b, a handwritten image including the retrieved character image may be applied to the image layer. For example, the electronic apparatus may retrieve characters constituting text related to a text insertion request, retrieve a character image corresponding to the retrieved character, and apply a handwritten image including the retrieved character image to the image layer, examples of which will be explained later by referring to FIGS. 7 to 11.

The electronic apparatus may perform, for text related to an edit request, an operation related to the edit request. For example, the electronic apparatus may insert text related to an insertion request into the text layer, or replace text related to a replacement request in the text layer.

FIG. 6 illustrates an example of deleting content in document data.

Referring to FIG. 6, in a case where text “it is” is to be deleted from a text layer, that is, the text “it is” is detected as text related to an edit request, a first handwritten image 611 and a second handwritten image 612a related to the detected text “it is” are identified in the image layer. The text to be deleted may be referred to as target text or deletion target text, and the first handwritten image 611 may indicate a handwritten image mapped to the deletion target text.

The second handwritten image 612a may indicate a handwritten image following the first handwritten image 611. The first handwritten image 611 and the second handwritten image 612a may be handwritten images located in the same line in the document data. The second handwritten image 612a may correspond to text following the text “it is” which is detected as the text related to the edit request. FIG. 6 illustrates left-to-right horizontal text. However, this is merely an example and operations described in the disclosure may be applied as right-to-left horizontal text, left-to-right vertical text, and right-to-left vertical text.

As illustrated in FIG. 6, the first handwritten image 611 mapped to the deletion target text “it is” is identified, and the identified first handwritten image 611 may be deleted from the image layer. The first handwritten image 611 may be covered in the image layer. As an example, the first handwritten image 611 may be covered by another object 613 in the image layer. For example, the first handwritten image 611 may be whited-out from the image layer. For example, a white object as the other object 613 maybe overlaid on the first handwritten image 611 to cover the first handwritten image 611 in the image layer. FIG. 6 illustrates the white object as the other object 613, but is not limited thereto. For example, an object having the same color and texture with a background of document data may be used to cover the first handwritten image 611.

After the first handwritten image 611 is covered by the other object 613, the second handwritten image 612b may be shifted. The second handwritten image 612b may be shifted to a reference location of the first handwritten image 611. The reference location of the first handwritten image 611 may be a location where the first handwritten image 611 starts in the image layer, but is not limited thereto. For example, the reference location of the first handwritten image 611 may be the left of the first handwritten image 611, and the second handwritten image 612b may be shifted to the left of the first handwritten image 611 or the object 613.

The shifted second handwritten image 612c may be overlaid on the object 613.

The example of FIG. 6 illustrates that the second handwritten image 612a, 612b, and 612c corresponds to text “that”, but is not limited thereto. For example, the second handwritten image may further include text following “that” on the same line. That is, the second handwritten image 612a, 612b, and 612c may include all handwritten images which are located in the same line as the first handwritten image 611 and following the first handwritten image 611. For example, the second handwritten image 612a, 612b, and 612c may include all handwritten images located on the same line as the first handwritten image 611 in the document data and located to the right of the first handwritten image 611.

FIG. 7 illustrates an example of retrieving text to insert content in document data.

Referring to FIG. 7, in a case where an edit request is a text insertion request and text related to the text insertion request is detected as the word “before”, the text “before” may be retrieved from a text layer 720. In a case where the text “before” is not available from the text layer 720, the electronic apparatus may sequentially attempt to retrieve text of “befor”, “befo”, “bef”, “be”, and “b”. Therefore, in a case where text “before” is already included in the text layer 720, the electronic apparatus may quickly retrieve from an image layer 710 a character image related to the text or a handwritten image including the character image. In a case where text related to the text insertion request consists of a plurality of words, text and a handwritten image may be retrieved based on each word.

FIG. 7 illustrates that the electronic apparatus retrieves text “be”. The electronic apparatus may sequentially attempt to retrieve text of “fore”, “for”, “fo”, “f”. FIG. 7 illustrates that “be”, “for” and “e” are retrieved sequentially, but a retrieval order is not limited thereto. For example, characters constituting text related to an edit request may be retrieved in parallel from the text layer 720.

The text and handwritten image may be retrieved within a predetermined range based on an edit location related to the edit request in the document data. For example, the text and handwritten image may be implemented to be retrieved from the same page as the edit location. Therefore, the retrieval may be made quickly.

Character images retrieved based on text related to an edit request may be connected or combined together according to the order of characters included in the text to constitute a first handwritten image 711. The first handwritten image 711 may include character images included in the image layer 710, but is not limited thereto. For example, at least a part of characters of the first handwritten image 711 may be retrieved from a font library.

The text related to the text insertion request may be inserted to a text insertion location. For example, the retrieved first handwritten image 711 may be applied to a region of the image layer 710 mapped to the text insertion location.

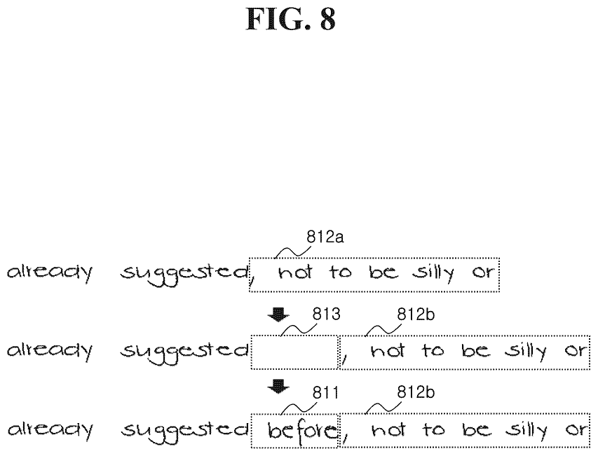

FIG. 8 illustrates an example of inserting content in document data.

Referring to FIG. 8, a region or a handwritten image following a location corresponding to a text insertion location may be identified as a second handwritten image 812a in an image layer. The second handwritten image 812a which comes after the text insertion location may be shifted for a first handwritten image 811 to be applied to the image layer. The second handwritten image 812a may be shifted by an area 813 to be occupied by the first handwritten image 811 applied to the image layer. The second handwritten image 812a may be shifted to the right by the length of the first handwritten image 811 applied to the image layer.

After the operation of text insertion is completed, the first handwritten image 811 and the shifted second handwritten image 812b may be located in the same line in the document data, the shifted second handwritten image 812b may follow the first handwritten image 811.

FIG. 8 illustrates that the first handwritten image 811 is applied to the image layer after the second handwritten image 812a is shifted in the image layer, but the process is not limited thereto. For example, the application of the first handwritten image 811 and the shift of the second handwritten image 812a may be performed simultaneously, or the second handwritten image 812a may be shifted after the first handwritten image 811 is applied to the image layer. For example, after the second handwritten image 812a is shifted in the image layer and the first handwritten image 811 is applied to the image layer, the shifted second handwritten image 812b may be further shifted to the left or right of the applied first handwritten image 811 in the image layer.

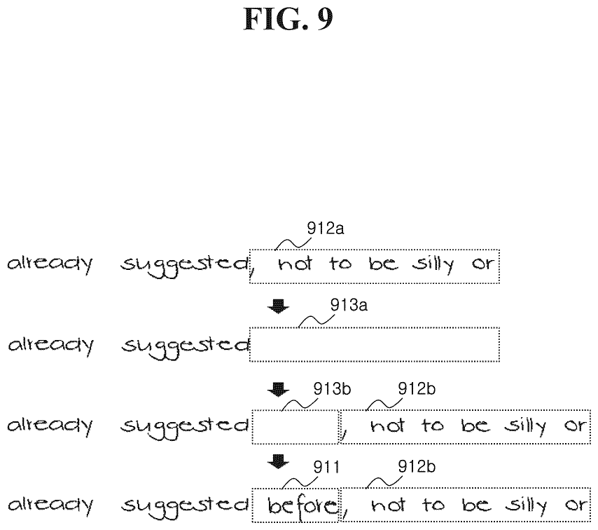

FIG. 9 illustrates an example of inserting content in document data.

Referring to FIG. 9, a region or a handwritten image following a location corresponding to a text insertion location may be identified as a second handwritten image 912a in an image layer. The second handwritten image 912a which comes after the text insertion location may be shifted for a first handwritten image 911 to be applied to the image layer. The second handwritten image 912a may be shifted by an area 913b to be occupied by the first handwritten image 911 applied to the image layer. The second handwritten image 912a may be shifted to the right by the length of the first handwritten image 911 applied to the image layer. Before the first handwritten image 911 is applied to the image layer, an object 913a such as a white object may be overlaid. The object 913a (e.g., the white object) may be overlaid on an area occupied by the second handwritten image 912a. The second handwritten image 912b and the first handwritten image 911 may be overlaid on the object 913.

FIG. 9 illustrates that the second handwritten image 912a is shifted after the object 913a is overlaid, but the process is not limited thereto. For example, the second handwritten image 912a may be shifted and the object 913a may be displayed under the shifted second handwritten image 912b and the first handwritten image 911.

FIG. 10 illustrates of an example of retrieving text to replace content in document data.

Referring to FIG. 10, in a case where an edit request is a text replacement request, and text related to the text replacement request, that is, target text and replacement text are “children” and “adults”, respectively, text corresponding to the replacement text “adults” may be retrieved from a text layer 1020. As shown in FIG. 10, each character constituting “adults” may be retrieved from the text layer 1020. Each character constituting “adults” may be retrieved simultaneously from the text layer 1020. The retrieval may be performed from the top to the bottom in the text layer 1020, but the process is not limited thereto. The retrieval may be performed from the bottom to the top in the text layer 1020, or may be performed in a random order.

Character images retrieved based on text related to an edit request may be connected or combined together according to the order of characters included in the text to constitute a first handwritten image 1011. The first handwritten image 1011 may include character images included in an image layer 1010, but is not limited thereto. For example, at least a part of characters of the first handwritten image 1011 may be retrieved from a font library.

The text related to the text insertion request may be inserted to a text insertion location in the text layer 1020, and the retrieved first handwritten image 1011 may be applied to a region of the image layer 1010 mapped to the text insertion location.

FIG. 11 illustrates an example of replacing content in document data.

In an example, processing a text replacement request for document data may be implemented by combining processes of a text insertion request and a text deletion request. Text related to the replacement request comprises target text and replacement text, an operation performed on the target text and a handwritten image mapped to the target text are substantially the same as an operation performed in response to the deletion request, and an operation performed on the replacement text and a handwritten image mapped to the replacement text are substantially the same as an operation performed in response to the insertion request, but are not limited thereto. For example, a replacement handwritten image applied to the image layer may be located on a target handwritten image related to the target text.

Referring to FIG. 11, an object 1113 may be overlaid on a target handwritten image 1111a related to the target text, a replacement handwritten image 1111b related to the replacement text may be overlaid on the object 1113, and the second handwritten image 1112 may not be shifted. For example, in a case where a difference in the number of characters between the target handwritten image 1111a and the replacement handwritten image 1111b or the target text and the replacement text are within a predetermined range, the second handwritten image 1112 may not be shifted. For example, in a case where a difference in the number of characters between the target handwritten image 1111a and the replacement handwritten image 1111b or the target text and the replacement text exceed a predetermined range, the second handwritten image 1112 may be shifted in proportion to the difference.

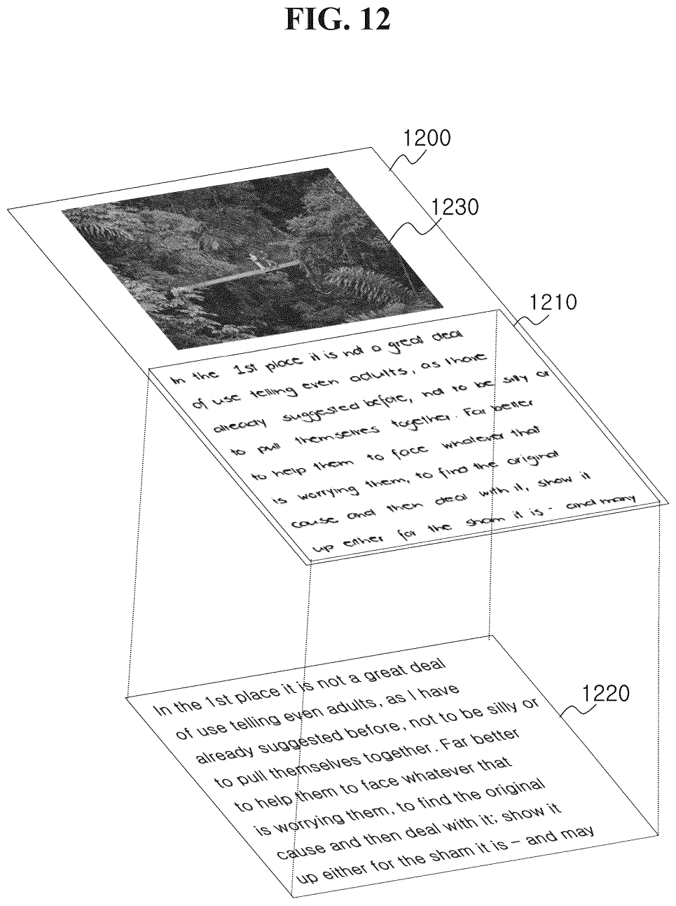

FIG. 12 illustrates an example of document data whose content is edited.

Referring to FIG. 12, a user may edit an image layer 1210 and a text layer 1220 of document data 1200 including a graphic object 1230 substantially simultaneously. If a user changes the text layer 1220, a handwritten image corresponding to the changed text may be changed. Therefore, edit and searching of the document data is effectively performed while maintaining readability of the document data.

FIG. 12 illustrates a final version of an image layer 1210 and a text layer 1220 after editing, but is not limited thereto. For example, an edit history of a user may be displayed in the image layer 1210 and the text layer 1220. For example, a strikethrough object may be overlaid on a first handwritten image corresponding to text to be deleted, instead of a white object. In a case where the strikethrough object is overlaid, the shift of the second handwritten image may not be performed. For example, an underline object may be displayed under the first handwritten image applied to the image layer.

FIG. 13 is a flowchart illustrating a method of editing document data according to an example.

Referring to FIG. 13, the electronic apparatus may receive an edit request of a user in operation 1310.

In operation 1312, a type of the edit request may be identified. In operation 1320, a handwritten image requested to be deleted may be whited-out in response to the edit request being a text deletion request.

In operations 1330 and 1340, the retrieval of text may be performed in response to the edit request being a text insertion request or a text replacement request. In a case where the text layer includes all characters constituting text to be retrieved, in operations 1336 and 1346, the electronic apparatus may configure a handwritten image from the characters to perform insertion and replacement. An example method of inserting text is explained as above by referring to FIGS. 7, 8, and 9, and a redundant description will be omitted. An example method of replacing text is explained as above by referring to FIGS. 10 and 11, and a redundant description will be omitted.

In operation 1350, edited text and the handwritten image may be saved to the document data.

In a case where the electronic apparatus fails to retrieve from the document data at least a part of the text requested to be inserted in operation 1332 or 1342, the electronic apparatus may perform DB matching with a font library to retrieve at least the part of the text in operations 1334 and 1344, an example of which will be explained by referring to FIG. 14.

FIG. 14 illustrates an example of searching for a font in order to insert content in document data.

Referring to FIG. 14, in a case where a user attempts to replace target text “first” with replacement text “1st” in the document data, text “st” which is in common in the target text and the replacement text may remain in the text data and the image data.

In order to replace a target handwritten image 1411a corresponding to the target text “fir” with the replacement handwritten image 1411b, the replacement text “1” may be retrieved from the text layer. In a case where the replacement text “1” is not retrieved from the text layer, the electronic apparatus may use a font library (e.g., DB). The font library (DB) may store font data regarding various fonts. The electronic apparatus or the font library (DB) may perform font classification on the input handwritten image to identify a font (e.g., Font 3) that is similar to the input handwritten image in the font library (DB). For example, the electronic apparatus may analyze a handwritten image on a line including the replacement text “1” to analyze font characteristics of the handwritten image, such as, curvature, inclination, shape, position, etc. of strokes in order to identify a font (e.g., Font 3) similar to the handwritten image in the font library (DB).

The electronic apparatus may retrieve an image 1411b corresponding to the replacement text “1” from the identified similar font (Font3) to overlay the image 1411b on an object 1413. Therefore, a valid handwritten image may be retrieved through the font library in a case where text related to the insertion or replacement request does not exist in a text layer.

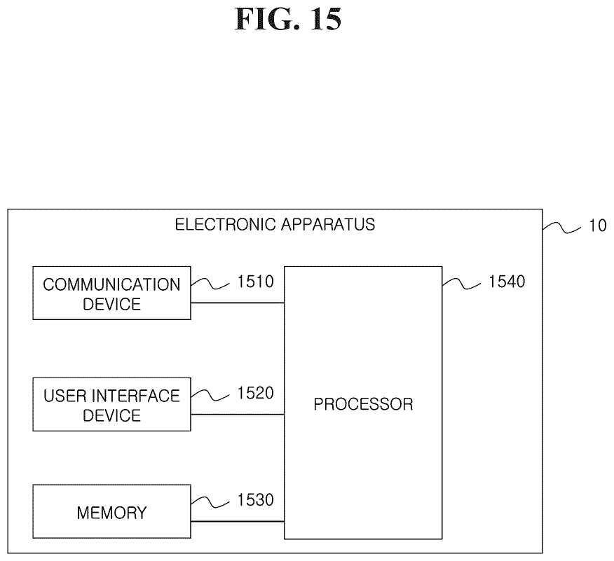

FIG. 15 is a block diagram illustrating an electronic apparatus according to an example.

Referring to FIG. 15, an electronic apparatus 10 may include a communication device 1510, a user interface device 1520, a memory 1530, and a processor 1540. However, the electronic apparatus 10 may be realized by more or fewer components than the illustrated components.

The communication device 1510 may communicate with an external apparatus. As an example, the communication device 1510 may be connected to a network in a wired or wireless manner and communicate with the external apparatus. Here, the external apparatus may be an electronic apparatus, a server, etc.

The communication device 1510 may include a communication module that supports one of various wired/wireless communication methods. For example, the communication module may be of a chipset type or may be a sticker/barcode (e.g., a sticker including a Near Field Communication (NFC) tag) including information for communication. Also, the communication module may be a short range communication module or a wired communication module.

For example, the communication device 1510 may support at least one of Wireless LAN, Wireless Fidelity (Wi-Fi), Wi-Fi Direct (WFD), Bluetooth, Bluetooth Low Energy (BLE), Wired Lan, NFC, Zigbee, infrared Data Association (IrDA), 3G, 4G, and 5G.

The user interface device 1520 may include an input unit to receive, from the user, an input of controlling an operation of the electronic apparatus 10 and an output unit to display a result according to the operation of the electronic apparatus 10 or information regarding a state of the electronic apparatus 10. For example, the user interface 1520 may include a manipulation panel for receiving a user input, a display panel for displaying a screen, etc.

As an example, the input unit may include a device to receive various types of user inputs, such as a keyboard, a physical button, a touchscreen, a camera, a microphone, and the like. Also, the output unit may include, for example, a display panel, a speaker, and the like. However, examples are not limited thereto, and the user interface device 1520 may include a device that supports various inputs and outputs.

The memory 1530 may store machine readable instructions or a program. For example, the memory 1530 may distinguish a writer based on handwritten text information that is read from an image of a scanned document including the handwritten text and store instructions regarding an operation method of the electronic apparatus 10 for generating a file regarding the document, based on setting information of the handwritten text and the distinguished writer.

The memory 1530 may include at least one of a flash memory type memory, a hard disk type memory, a multimedia card micro type memory, a card type memory (e.g., a secure digital (SD) memory, an extreme digital (XD) memory, etc.), a random access memory (RAM), a static RAM (SRAM), a read-only memory (ROM), a programmable ROM (PROM), an electrically erasable PROM (EEPROM), a magnetic memory, a magnetic disk, an optical disc, etc.

The processor 1540 may control an operation of the electronic apparatus 10 and may include at least one processor such as a Central Processing Unit (CPU). The processor 1540 may include at least one processor for each function or one integrated processor.

The processor 1540 may execute a program stored in the memory 1530, read data or a file stored in the memory 1530, or store new data or a file in the memory 1530. The processor 1540 may execute instructions stored in the memory 1530.

The processor 1540 may obtain an image regarding the document including the handwritten text.

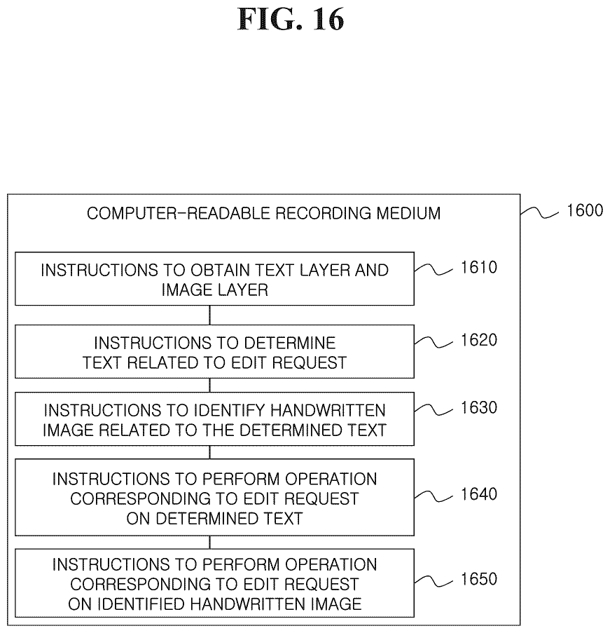

FIG. 16 is a diagram illustrating instructions stored in a non-transitory computer-readable recording medium according to an example.

As shown in FIG. 16, a non-transitory computer-readable recording medium 1600 may include instructions 1610 to obtain a text layer and an image layer, instructions 1620 to detect text related to an edit request of a user, instructions 1630 to identify a handwritten image related to the detected text, instructions 1640 to perform an operation related to the edit request on the detected text, and instructions 1650 to perform an operation related to the edit request on the identified handwritten image. The non-transitory computer-readable recording medium 1600 may include more or fewer instructions than the instructions illustrated in FIG. 16.

The instructions 1630 to identify the handwritten image related to the detected text may include instructions to retrieve at least one character constituting the detected text from the text layer, and instructions to retrieve at least one character image mapped to the retrieved at least one character. The handwritten image identified as being related to the detected text may include at least one character image retrieved from the image layer.

The instructions 1630 to identify the handwritten image related to the detected text may include instructions to detect font data corresponding a handwritten image of the image layer, and instructions to retrieve from the font data at least one character constituting the detected text. The handwritten image identified as being related to the detected text may include at least one character image retrieved from the font data.

Other functions of the instructions are substantially the same as those described above, redundant descriptions are omitted.

An example operation method of the electronic apparatus 10 may be realized as a non-transitory computer-readable recording medium storing therein a command, an instruction, or data executable by a computer or a processor. The above-described example operation method of the image forming device may be written in a program executable by a computer, and may be implemented in a general-purpose digital computer that operates such a program using a non-transitory computer-readable storage medium. Examples of such a non-transitory computer-readable storage medium may include read-only memory (ROM), random-access memory (RAM), flash memory, compact disc (CD)-ROMs, CD-recordables (Rs), CD+Rs, CD-rewritables (RWs), CD+RWs, and digital versatile disc (DVD)-ROMs, DVD-Rs, DVD+Rs, DVD-RWs, DVD+RWs, DVD-RAMs, blu-ray disc (BD)-ROMs, BD-Rs, BD-recordable low to highs (R LTHs), BD-REs, magnetic tapes, floppy disks, magneto-optical data storage devices, optical data storage devices, hard disks, solid-state disks (SSDs), and any device capable of storing machine readable instructions, associated data, data files, and data structures, and providing a processor or computer with machine readable instructions, associated data, data files, and data structures such that the processor or computer may execute the instructions.

While various examples have been explained with reference to the accompanying drawings, modifications and changes of the examples may be made. For example, the techniques described may be performed in a different order than the described methods, and/or the described systems, structures, devices, circuits, or any components may be integrated or combined in a different form than the described methods, or may be replaced or substituted by other components or their equivalents, in order to achieve an appropriate result.

It should be understood that examples described herein should be considered in a descriptive sense and not for purposes of limitation. Descriptions of features or aspects within each example should typically be considered as available for other similar features or aspects in other examples. While examples have been described with reference to the figures, it will be understood that various changes in form and details may be made therein without departing from the spirit and scope as defined by the following claims.

What is claimed is:

1. An electronic apparatus comprising:
a processor; and
a memory to store instructions executable by the processor, wherein the processor, by executing the instructions, is to:
obtain, for a document including handwritten text, a text layer including text and an image layer including a handwritten image corresponding to the text;
detect text related to an edit request of a user;
retrieve, in the text layer, at least one character constituting the detected text,
retrieve, in the image layer, at least one character image mapped to the retrieved at least one character; and
apply a first handwritten image including the retrieved at least one character image to the image layer.

2. The electronic apparatus of claim 1,
wherein the edit request comprises a text insertion request, and
wherein the processor, by executing the instructions, is to:
insert the detected text into a text insertion location related to the text insertion request in the text layer; and
apply the first handwritten image to a region of the image layer which is mapped to the text insertion location.

3. The electronic apparatus of claim 2, wherein the text insertion location and the retrieved at least one character image are located within a predetermined range.

4. The electronic apparatus of claim 2, wherein the text insertion location and the retrieved at least one character image are located within a same page of the document.

5. The electronic apparatus of claim 1,
wherein the at least one character constituting the detected text comprises a first character and a second character,
wherein the at least one character image comprises a first character image and a second character image respectively corresponding to the first character and the second character, and
wherein the first handwritten image is completed by connecting the first handwritten image and a second handwritten image.

6. The electronic apparatus of claim 1, wherein the at least one character constituting the detected text is included in the text layer.

7. The electronic apparatus of claim 1,
wherein, in a case in which the at least one character constituting the detected text is not included in the text layer, the processor, by executing the instructions, is to:
determine font data corresponding to the handwritten image in a font database; and
retrieve, in the font data, at least one character image corresponding to the at least one character constituting the detected text, and
wherein the first handwritten image comprises the at least one character image retrieved in the font data.

8. The electronic apparatus of claim 1, wherein the processor, by executing the instructions, is to shift, in the image layer, a second handwritten image corresponding to a text edit location related to the edit request.

9. The electronic apparatus of claim 8,
wherein the edit request comprises a text insertion request,
wherein the text edit location comprises a text insertion location related to the text insertion request,
wherein the second handwritten image is located in a same line as the text insertion location in the image layer, and
wherein the second handwritten image shifted in the image layer follows the first handwritten image applied to the image layer.

10. The electronic apparatus of claim 1,
wherein the edit request comprises a text insertion request,
wherein the processor, by executing the instructions, is to:
overlay, in the image layer, an object on a second handwritten image corresponding to a text insertion location related to the text insertion request; and
shift the second handwritten image in the image layer, and
wherein the first handwritten image applied to the image layer and the second handwritten image shifted in the image layer are located on the object.

11. The electronic apparatus of claim 1,
wherein the edit request comprises a text deletion request to delete deletion target text, and the text related to the edit request comprises the deletion target text,
wherein the processor, by executing the instructions, is to:
overlay, in the image layer, an object on a target handwritten image mapped to the deletion target text; and
shift a second handwritten image following the target handwritten image in the image layer, and
wherein the shifted second handwritten image is located on the object.

12. The electronic apparatus of claim 1,
wherein the edit request comprises a text replacement request to replace target text with replacement text,
wherein the text related to the edit request comprises the replacement text,
wherein the at least one character constitutes the replacement text, and
wherein the processor, by executing the instructions is to:
replace the target text with the replacement text in the text layer; and
apply, in the image layer, the first handwritten image onto a target handwritten image mapped with the target text.

13. The electronic apparatus of claim 12, wherein
the processor, by executing the instructions, is to overlay, in the image layer, an object on the target handwritten image, and
the first handwritten image applied in the image layer is located on the object.

14. A non-transitory computer-readable storage medium storing instructions executable by a processor, the computer-readable storage medium comprising:
instructions to obtain, for a document including handwritten text, a text layer including text and an image layer including a handwritten image corresponding to the text;
instructions to detect text related to an edit request of a user;
instructions to retrieve, in the text layer, at least one character constituting the detected text;
instructions to retrieve, in the image layer, at least one character image mapped to the retrieved at least one character; and
instructions to apply a first handwritten image including the retrieved at least one character image to the image layer.

15. A method comprising:
obtaining, for a document including handwritten text, a text layer including text and an image layer including a handwritten image corresponding to the text;
detecting text related to an edit request of a user;
retrieving, in the text layer, at least one character constituting the detected text;
retrieving in the image layer, at least one character image mapped to the retrieved at least one character; and
applying a first handwritten image including the retrieved at least one character image to the image layer.
